(19) United States
(12) Patent Application Publication
(10) Pub. No.: US 2004/0144272 A1
(43) Pub. Date: Jul. 29, 2004

(54) Multiple-Stand Gravure Printing Machine and Gravure Printing Process

(75) Inventors: Wilfried Kolbe, Gulzow (DE); Klaus Schirrich, Bielefeld (DE); Andreas Kuckelmann, Ibbenburen (DE); Ralf Mulch, Bad Salzuflen (DE); Bodo Steinmeier, Bielefeld (DE)

Correspondence Address: RICHARD M. GOLDBERG, 25 EAST SALEM SREEET, SUITE 419, HACKENSACK, NJ, 07601, US

(73) Assignee: Fischer & Krecke GmbH & Co., Bielefeld (DE)

(21) Appl. No.: 10/688,554

(22) Filed: Oct. 17, 2003

(30) Foreign Application Priority Data
Jan. 25, 2003 (EP) 03 001 669.5

(51) Int. Cl. B41F 13/02

(52) U.S. Cl. 101/228

(57) ABSTRACT

Multiple-stand photogravure machine with a first (10) and at least an additional printing unit (12a, 12b), each containing an impression roller (32, 52) and a driven print cylinder (34, 54), characterized in that in the at least one additional printing unit (12a, 12b) the impression roller (52) is provided with a regulated drive (56) and is in contact with the printable material (16) such that it can sustain a web velocity of the printable material (16) different from the circumferential speed of the adjoining print cylinder (54).

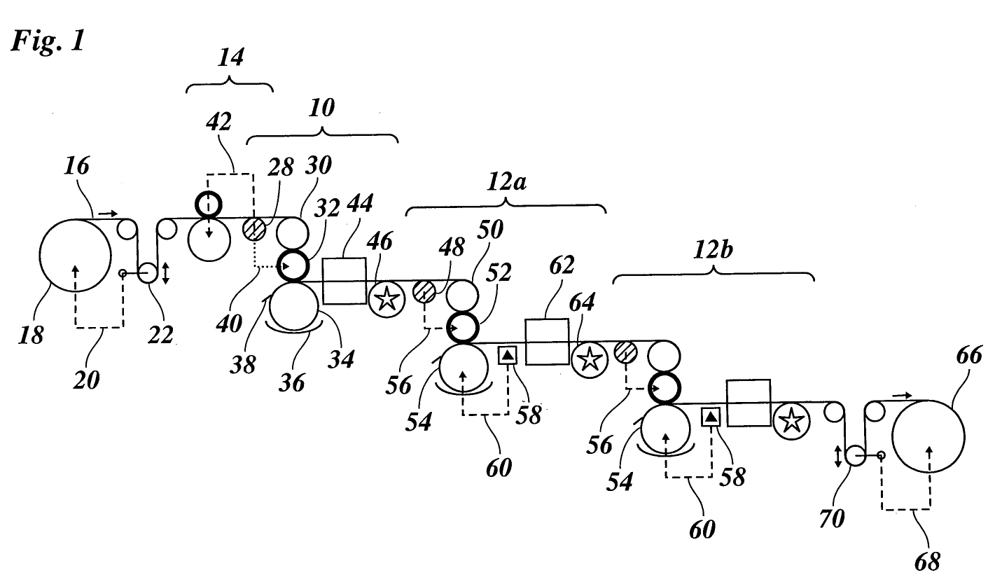

The invention relates to a multiple-stand photogravure machine with a first printing unit and at least one additional printing unit, which contain in each case each an impression roller and a driven print cylinder, as well as a photogravure printing process for such a photogravure machine.

In a conventional photogravure machine a web of printable material runs through a gap between a driven photogravure machine and a non-driven cylinder—the so-called impression roller—which presses the web against the photogravure cylinder. When a plurality of images is to be overprinted in accurate register—for example in multi-color printing—a plurality of printing units, also known as stands, are arranged in series. After each stand, the web passes through a dryer and a cooler and is then fed to the next printing unit where another image is overprinted such that it is in the correct position with respect to the image previously printed. This is controlled by means of register marks, which are applied to the printable material web and are detected optically. So that, on the one hand, the register accuracy will be sustained and, on the other hand, the web tension applied to the web by the driven print cylinders will remain constant, the print cylinders must be driven at exactly the same rotational speed and they must also have exactly the same diameter. If the diameters of the print cylinders differ from one another but slightly, by a few tenths of a millimeter, the print lengths of the imprinted images will differ slightly from one another according to the circumference of the print cylinder and the transport velocities with which the web is transported through the various printing units will also vary. The result can be that the web between the individual printing units may increasingly sag or instead become excessively taut. If the speeds of the print cylinders are matched so that the web tension remains constant, the different print lengths accumulate over time to become a perceptible registration error.

It is the object of the invention to create a control system permitting register accuracy at constant web tension. Furthermore, a method is to be created, whereby printing can be started and carried out and in which accurate register control is performed at constant web tension.

Pursuant to the invention, this objective is achieved owing to the fact that, in a photogravure machine of the kind referred to above, the impression rollers are also provided with a controlled drive and are in contact with the printable material, so that they can sustain a web velocity on the printable material varying from the circumferential speed of the print cylinder applied to them.

The velocity of the web transport is then determined in a printing unit, no longer by the rotational speed of the print cylinder but by the rotational speed of the impression roller. At the same time, differences in the circumferential speed of the print cylinder relative to the printable material can be compensated. The assumption is that the web adheres better to the circumferential surface of the impression roller better than it does to the circumferential surface of the print cylinder. This can be brought about by passing the web above the impression roller on an idler, so that it wraps around the impression roller on a greater circumferential length. In some cases, however, even a sufficient contact force between impression roller and print cylinder, combined with the nature of the surface of the impression roller, will suffice for good adherence.

An inventive method, by which a printing process can be started and carried on, has the features of the independent claim 5.

Advantageous embodiments of the invention are to be found in the dependent claims.

In a preferred embodiment of the photogravure machine of the invention, during the print operation the drive of the impression roller of the first printing unit determines the web velocity for the drives of the other impression rollers. The impression roller drives in the added printer units are regulated in a closed control circuit such that the web tension remains constant. The web tension ahead of the particular printer unit is measured by means of a measuring roller, and the impression roller drive is varied according to the measured web tension. In this manner, a uniform and constant web tension is assured over all of the printer units.

Preferably, the drive of the print cylinder of the first printer unit determines the speed of the next print cylinder in order. Ideally, all print cylinders run at precisely the same rotational speed. If the diameter of the next-following print cylinder is slightly too great, a slippage occurs in the printer unit involved, between the print cylinder and the web. However, this does not perceptibly impair the printed image. By means of an optical sensor, the register marks are detected in back of the print cylinder, and a register error Δφ of the newly printed image is measured with reference to the register marks. The print cylinder is then briefly accelerated or retarded in order to compensate the register error.

In this way, if the web tension is uniform it is possible to achieve a uniform web transport at constant web velocity, while with a uniform, constant rotary speed of the print cylinders, with in some cases a slight slippage of the print cylinders relative to the printable material, printing in perfect register is achieved. But this slight slippage does not visibly impair the printed image.

The drives of all of the impression rollers and print cylinders are preferably electronically controlled servo drives by which a function φ(t), describing the rotational angle φ at the time t, can be preset and varied if necessary. To compensate a register error Δφ, the servo drive of the print cylinder in question then receives a command to accelerate or slow momentarily, so that the rotational angle will lead or lag relative to another print cylinder. Accordingly, the image shifts on the web so that the register error is compensated.

In the inventive method, with which such a printing process can be initiated and carried on, three phases can be distinguished: the start-up, in which the web is brought to the desired speed and is not yet printed; the proofing in which each print cylinder produces a printed image and the rotational speeds are controlled so that accurate register is achieved; and the print run in which the machine runs steadily and only the gradually accumulated register errors as well as gradually accumulated departures from the set value of the web tension are equalized.

The steps of start-up and proofing are performed in a manner known in itself, yet the impression rollers are energized and the web tension is regulated accordingly.

Preferably, a draw-in mechanism precedes the first printing unit and determines the web velocity during start-up. The impression roller drives of all of the printing units that follow are then regulated by adapting the rotational speed in control circuits, so that the desired web tension is produced everywhere. The drive of the first impression roller is determined by the web tension, which is measured by the measuring roller between the draw-in mechanism and a first printing unit. After start-up, this measuring roller controls only the drive of the draw-in mechanism, and the first impression roller runs at constant rotational speed.

During proofing the drives of the impression rollers and draw-in mechanism are regulated in the described manner until all speeds are correctly adjusted. Then the print run begins, in which the angular positions of the impression rollers and draw-in mechanism are adjusted only incrementally in order to compensate for fluctuations between set and actual values of the web tension.

The control of the drives of the print cylinders is performed during proofing, when the first print cylinder establishes the rotational speed for the other print cylinders, and the drives of the other print cylinders are regulated by means of optical sensors which sense the register marks so that the result is accuracy of registration in the printing.

In the print run the print cylinders that follow run in step with the first print cylinder, so that register accuracy is sustained. Under some circumstances, a slippage occurs between the print cylinder and web in the printing units that follow, since the speed of the web is determined by the impression rollers. During the print run, the regulation of the drives of the print cylinder is carried on whereby register errors are compensated by brief acceleration or slowing of a print cylinder. In the preferred embodiment of the drives as electronically controlled servo drives, the described incremental variation of the angle of rotation to compensate for register errors can be simply achieved.

A preferred, inventive embodiment will be explained herein below with the aid of the drawing.

The single FIGURE of the drawing shows schematically the structure of a multi-stand photogravure machine with three printing units.

The photogravure machine represented has a first printing unit 10 and two additional printing units 12a and 12b. At the start of the path of the web 16 through the gravure machine is a reel 18, the drive of which is controlled by a control circuit 20 according to the level of a dancer roll 22. The web 16 then runs through a gap between two cylinders of a draw-in mechanism 14 and passes a first metering roll 28, which measures the web tension.

In the first printing unit 10, the web 16 passes around an idler 30 and an impression roller 32, and is then carried through a gap between the impression roller 32 and a first print cylinder 34. An ink trough 36 and a doctor blade 38 are shown in the print cylinder 34. Only during start-up does a control circuit 40 regulate the drive of the impression roller 32 according to the web tension, which is measured by the metering roll 28. In printing operation, i.e., during the proofing and the print run, the measuring cylinder 28 is part of a control circuit 42, which controls the drive of the draw-in mechanism 14. In the printing operation, the drive of impression roller 32 determines the speed of the web 16 for the printing unit 10 and the additional printing units 12a and 12b.

After the print cylinder 34, the web runs through a dryer 44 and a cooler 46.

In the second printing unit 12a, the web tension is again measured by a measuring cylinder 48 before the web is carried over an idler 50 and an impression roller 52 to a print cylinder 54. The measurement of the web tension by the measuring roll 48 is entered into a control circuit 56, which regulates the drive of the impression roller 52. In back of the print cylinder 54 is an optical sensor 58, which optically senses the register marks applied to the web 16. Registration errors thus measured are compensated by a circuit 60 controlling the drive of the print cylinder 54. A dryer 62 and cooler 64 again follow.

The printing unit 12b next following is constructed the same as the printing unit 12a. At the end of the path of the web 16, the web 16 is wound onto a roll 66 whose drive is regulated by a control circuit 68 according to the level of a dancer roll 70.

While during start-up, the draw-in mechanism 14 establishes the speed of the web 16 and the control circuits 40 and 56 regulate the drives of impression rollers 32 and 52, and in the printing run the control circuit 40 is inactive. Instead, here the control circuit 42 regulates the drive of the draw-in mechanism 14, while the drive of impression roller 32 establishes the web velocity for the entire gravure machine.

The print cylinder 34 sets the rotational speed of all additional print cylinders 54. In the case of start-up, the drive of the print cylinder 54 is regulated in each case through the optical sensors 58 and the control circuits 60 such that the register accuracy of the print is achieved.

In the print run, the first printing unit 10 sets both the rotational speed of the draw-in mechanism 14 and of the impression rollers 52 of the printing units 12a and 12b, as well as the rotational speeds of the print cylinders 54 of the two printing units 12a and 12b. The control circuits 42, 56 and 60 are then operated so that their time-related required angular position is corrected incrementally in case any departure from the set value of the web tension at the particular metering roll 28 or 48 is detected, or if the optical sensing of the register marks at the particular optical sensor 58 indicates a register error.

Although the invention has here been represented with the aid of an example with three printing units 10, 12a and 12b, it is by no means limited to this number. Also, a different arrangement or assembly of the elements of each printing unit 10, 12a or 12b is conceivable. For example, the idlers 30 and 50 can be omitted if a sufficient pressing force between impression roller and print cylinder, combined with an impression roller surface quality that provides for good adhesion, it is assured that the impression roller presets the velocity of the web 16. In the first printing unit 10, the drive of impression roller 32 can be omitted, since sometimes the same circumferential speed of impression roller 32 and print cylinder 34 is desired.

1. Multi-stand photogravure machine with a first (10) and at least one additional printing unit (12a; 12b) each containing an impression roller (32; 52) and a driven print cylinder (34, 54), characterized in that, in the at least one additional printing unit (12a; 12b), the impression roller (52) is provided with a regulated drive (56) and is in contact with the printable material (16), so that it can sustain a web velocity of the printable material (16) varying from the circumferential speed of the contacting print cylinder (54).

2. Multi-stand photogravure machine of claim 1, characterized in that, in the at least one additional printing unit (12a), the regulated drive (56) of the impression roller (52) contains a metering roll (48), which is disposed adjacent to the course of the web and measures the web tension.

3. Multi-stand photogravure machine of claim 1 or 2, characterized in that each driven impression roller (52) has a drive, in which an acceleration or deceleration can be set with respect to another impression roller (32).

4. Multi-stand photogravure machine of one of the preceding claims, characterized in that the print cylinder (54) of the at least one additional printing unit (12a; 12b) has a drive, in which an acceleration or deceleration with respect to the print cylinder (34) of the first printing unit (10) can be set.

5. Photogravure process for a multi-stand photogravure machine with a first (10) and at least one additional printing unit (12a; 12b), each containing an impression roller (32, 52) and a driven print cylinder (34; 54), characterized in that the impression roller (52) of the at least one additional printing unit (12a; 12b) is actively driven and that, by means of the drive of the impression roller (52) of the at least one additional printing unit (12a, 12b), the web tension of a web (16) is regulated.

6. Photogravure process of claim 5, characterized in that, upon the start-up of the photogravure machine, when the print cylinders (34; 54) are brought to a uniform, regulated rotational speed, the web velocity is set by a draw-in mechanism (14) and the rotational speed of each driven impression roller (32, 52) is so regulated that a uniform web tension results in all printing units (10, 12a, 12b).

7. Photogravure process of claim 5 or 6, characterized in that, upon start-up, the impression roller (32) of the printing unit (10) adjacent to one draw-in mechanism (14) sets the web velocity, and the rotational speed of a draw-in mechanism (14) and impression roller (52) of the at least one additional printing unit (12a; 12b) are regulated, so that a uniform web tension results.

8. Photogravure process of one of the claims 5 to 7, characterized in that, during start-up, the rotational speed of the print cylinder (54) in the at least one additional printing unit (12a, 12b) is regulated by means of an optical sensor (58) so that register accuracy is achieved.

9. Photogravure process of one of the claims 5 to 8, characterized in that, during the run time, the rotational speeds of the impression rollers (32, 52) attained in the start-up are sustained and a reaction is made to departures from the uniform web tension with brief variations of a set speed of a driven impression roller (52) from the rotational speed reached during start-up.

10. Photogravure process of one of the claims 5 to 9, characterized in that, during run time, the speeds of the print cylinders (34, 54) reached during start-up are sustained and a reaction is made to register errors with brief departures of a set speed from the speed reached during start-up.

11. Photogravure process of claim 9, characterized in that, to produce the brief departure of the set speed of a driven impression roller (52), an acceleration or deceleration with respect to another impression roller (32) is established at the drive of the impression roller (52).

12. Photogravure method of claim 10, characterized in that, to produce the brief departure of the set speed of a print cylinder (54), an acceleration or deceleration, with respect to another print cylinder (34), is established at the drive of the print cylinder (54).
